(19) United States
(12) Patent Application Publication
(10) Pub. No.: US 2011/0043609 A1
(43) Pub. Date: Feb. 24, 2011

(54) APPARATUS AND METHOD FOR PROCESSING A 3D IMAGE

(76) Inventors: Seung Wook CHOI, Seongnam-si (KR); Min Kyu Lee, Yongin-si (KR)

Correspondence Address: BIRCH STEWART KOLASCH & BIRCH, PO BOX 747, FALLS CHURCH, VA, 22040-0747, US

(21) Appl. No.: 12/720,421

(22) Filed: Mar. 9, 2010

(30) Foreign Application Priority Data
Aug. 18, 2009 (KR) 10-2009-0076290

(51) Int. Cl. H04N 13/02; G06K 9/00

(52) U.S. Cl. 348/46; 382/154; 348/E13.074

(57) ABSTRACT

Provided are an apparatus and a method for processing a three dimensional image. The apparatus for processing the three dimensional image includes a lattice pattern projection unit configured to project a reference lattice pattern onto a photographic object; a photographing unit configured to generate an image information by photographing the photographic object onto which the reference lattice pattern is projected; a depth information extraction unit configured to extract a depth information of the photographic object based on comparison between the reference lattice pattern projected onto the photographic object and a modified lattice pattern included in the image information; and a left and right eye information generation unit configured to generate a left and right eye information in correspondence with the depth information, the left and right eye information containing a three dimensional information of the photographic object.

### CROSS-REFERENCE TO RELATED APPLICATIONS

This application claims the benefit of Korean Patent Application No. 10-2009-0076290 filed with the Korean Intellectual Property Office on Aug. 18, 2009, the disclosures of which are incorporated herein by reference in their entirety.

### BACKGROUND OF THE INVENTION

The present invention relates to an electronic apparatus, and more particularly to an apparatus and a method for processing a three dimensional (3D) image.

Surgery is a medical term that refers to a procedure that involves cutting, excising or maneuvering a patient's skin, mucous membrane, tissue or the like by using a medical device in order to treat a pathological condition such as disease. Particularly, an open laparotomy is a surgical procedure that involves an incision through an abdominal wall or facial skin to gain access into organs therein so as to treat, manipulate or remove the organs. However, since laparotomy cause blood loss, pain, scarring and other symptoms after the procedure, a laparoscopic surgery, which is performed through a small opening in the skin surface, or a robot-assisted surgery has become an increasingly popular treatment.

In the laparoscopic surgery or the robot-assisted surgery, a stereoscope is used to provide a three dimensional visual information of an operative field. Generally, the stereoscope employs two lenses to present different images to each eye of a viewer corresponding to a difference in perspective between two eyes, i.e., a difference of image formed on a retina of each eye. In this way, a three dimensional imaging effect of an object can be produced.

Since a camera used in the conventional laparoscopic surgery is required to have at least two lenses, more space is occupied and accompanying components need to have high design complexity. However, in order to improve user convenience in performing the laparoscopic surgery or the robot-assisted surgery, the use of smaller equipment is desirable because the surgery is operated by inserting into a patient's body as many surgical instruments as needed, instead of opening up the body. The surgical instrument may include, for example, the stereoscope, a skin holder, a suction line, or an effector.

The above information disclosed in this Background section is retained or acquired by the inventor in an effort to realize the object of the invention, and therefore it may contain information that does not form the prior art that is already known to the public.

### SUMMARY OF THE INVENTION

The present invention has been made in view of the above problems, and provides an apparatus and a method in which a three dimensional information can be produced by using a single photographing unit, for example, a lens.

The present invention further provides an apparatus and a method in which a user is provided with an actual three dimensional image of a photographic object from which a lattice pattern used for producing a three dimensional image is removed.

In accordance with an aspect of the present invention, provided is an apparatus for processing a three dimensional image, which includes: a lattice pattern projection unit configured to project a reference lattice pattern onto a photographic object; a photographing unit configured to generate an image information by photographing the photographic object onto which the reference lattice pattern is projected; a depth information extraction unit configured to extract a depth information of the photographic object by using the generated image information; and a left and right eye information generation unit configured to generate a left and right eye information in correspondence with the depth information, the left and right eye information containing a three dimensional information of the photographic object.

In one example embodiment, the depth information extraction unit may extract the depth information of the photographic object based on comparison between the reference lattice pattern projected onto the photographic object and a modified lattice pattern included in the image information.

In one example embodiment, the depth information of the photographic object may be extracted by the depth information extraction unit by using an information of at least one of a distance between adjacent lines forming the modified lattice pattern, a width, a gradient or a variation of the gradient of the line.

In one example embodiment, projection of the reference lattice pattern by the lattice pattern projection unit onto the photographic unit may be turned on or turned off corresponding to a predetermined period.

In one example embodiment, the lattice pattern projection unit may include a flickering control unit that controls such that a projection light including the reference lattice pattern flickers corresponding to the predetermined period, or include a mirror unit configured to rotate corresponding to the predetermined period to reflect a projection light including the reference lattice pattern toward the photographic object.

In one example embodiment, the lattice pattern projection unit may include a prism configured to refract a projection light including the reference lattice pattern in a direction toward the photographic object.

In one example embodiment, the photographing unit may photograph the photographic object onto which the reference lattice pattern is projected and the photographic object onto which the reference lattice pattern is not projected, respectively, to generate the image information. In addition, the photographing unit may alternately photograph the photographic object onto which the reference lattice pattern is projected and the photographic object onto which the reference lattice pattern is not projected.

In one example embodiment, the depth information extraction unit may extract the depth information of the photographic object by using the image information generated by photographing the photographic object onto which the reference lattice pattern is projected. In addition, the left and right eye information generation unit may generate the left and right eye information that contains the three dimensional information of the photographic object in correspondence with the depth information by using the image information generated by photographing the photographic object onto which the reference lattice pattern is not projected.

In one example embodiment, the lattice pattern projection unit may be rotatably coupled to the endoscope by using a hinge connection. In addition, the apparatus may further include a rotation means coupled to one end of the lattice pattern projection unit to rotate the lattice pattern projection unit. The rotation means may be any one of a wire, a gear or a bar type rod.

In one example embodiment, the apparatus may further include a first mirror configured to allow a projection light that is emitted from the lattice pattern projection unit and is incident on a first surface thereof to pass therethrough and configured to reflect a light that is reflected from the photographic object and is incident on a second surface thereof In addition, the apparatus may further include a second mirror positioned in a front end of the lattice pattern projection unit to reflect the projection light toward the first mirror.

In one example embodiment, an optical unit that includes at least one of the lattice pattern projection unit, the photographing unit, the first mirror and the second mirror may be positioned within an endoscope or is provided in a separate device that is attachable/detachable to/from the endoscope.

In accordance with another aspect of the present invention, provided is an apparatus for processing a three dimensional image configured to couple to an endoscope, the apparatus including: a lattice pattern projection unit configured to project a reference lattice pattern onto a photographic object; an engagement unit coupled to a first side of the lattice pattern projection unit, the engagement unit being attachable/detachable to/from the endoscope; a photographing unit configured to generate an image information by photographing the photographic object onto which the reference lattice pattern is projected; a depth information extraction unit configured to extract a depth information of the photographic object by using the generated image information; and a left and right eye information generation unit configured to generate a left and right eye information in correspondence with the depth information, the left and right eye information containing a three dimensional information of the photographic object.

In one embodiment, the lattice pattern projection unit may be rotatably coupled to the endoscope by using a hinge connection. In addition, the endoscope may be coaxially connected to the engagement unit. Also, the apparatus may further include a rotation means coupled to one end of the lattice pattern projection unit to rotate the lattice pattern projection unit. The rotation means may be any one of a wire, a gear or a bar type rod.

In accordance with still another aspect of the present invention, provided is a method of processing a three dimensional image, which includes: projecting a reference lattice pattern onto a photographic object; generating an image information by photographing the photographic object onto which the reference lattice pattern is projected; extracting a depth information of the photographic object by using the generated image information; and generating a left and right eye information in correspondence with the depth information, the left and right eye information containing a three dimensional information of the photographic object.

In one example embodiment, in the extracting of the depth information, the depth information of the photographic object may be extracted based on comparison between the reference lattice pattern projected onto the photographic object and a modified lattice pattern included in the image information. In addition, in the extracting of the depth information, the depth information of the photographic object is extracted by, for example, using an information of at least one of a distance between adjacent lines forming the modified lattice pattern, a width, a gradient or a variation of the gradient of the line.

In one example embodiment, in the generating of the left and right eye information, the three dimensional information of the photographic object may be generated in correspondence with the extracted depth information, and the left and right eye information may be generated based on the generated three dimensional information, wherein the left and right eye information corresponds to a perspective difference between left and right eyes.

In one example embodiment, in the projecting of the reference lattice pattern, projection of the reference lattice pattern onto the photographic unit may be turned on or turned off corresponding to a predetermined period. In this case, in the generating of the image information, the photographic object onto which the reference lattice pattern is projected and the photographic object onto which the reference lattice pattern is not projected may be respectively photographed to generate the image information. For example, in the generating of the image information, the photographic object onto which the reference lattice pattern is projected and the photographic object onto which the reference lattice pattern is not projected may be alternately photographed.

In one example embodiment, in the generating of the left and right eye information, the left and right eye information that contains the three dimensional information of the photographic object may be generated in correspondence with the depth information by using the image information generated by photographing the photographic object onto which the reference lattice pattern is not projected.

In one example embodiment, in the extracting of the depth information, the depth information of the photographic object may be extracted by using the image information generated by photographing the photographic object onto which the reference lattice pattern is projected. In addition, in the generating of the left and right eye information, the left and right eye information that contains the three dimensional information of the photographic object may be generated in correspondence with the depth information by using the image information generated by photographing the photographic object onto which the reference lattice pattern is not projected.

In accordance with still another aspect of the present invention, provided is a recordable media with an executable program command stored thereon, which is executed by a digital processing apparatus to perform the method of processing the three dimensional image described above.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a three dimensional image processing apparatus according to an example embodiment of the present invention;

FIG. 2 is a block diagram illustrating a three dimensional image processing apparatus according to another example embodiment of the present invention;

FIG. 3 is a block diagram illustrating a three dimensional image processing apparatus according to still another example embodiment of the present invention;

FIG. 4 is a block diagram illustrating a three dimensional image processing apparatus according to still another example embodiment of the present invention;

FIG. 5 illustrates a state of a three dimensional image processing apparatus according to an example embodiment of the present invention being coupled to an endoscope;

FIG. 6 illustrates a state of a three dimensional image processing apparatus according to another example embodiment of the present invention being coupled to an endoscope;

FIG. 7A illustrates a state of a three dimensional image processing apparatus according to still another example embodiment of the present invention being coupled to an inside of an endoscope;

FIG. 7B illustrates a state of a three dimensional image processing apparatus in FIG. 7A being coupled to an endoscope, wherein the three dimensional image processing apparatus is provided as a separate unit;

FIG. 8 illustrates a state of a three dimensional image processing apparatus according to still another example embodiment of the present invention being coupled to an endoscope; and

FIG. 9 is a flowchart illustrating a method of processing a three dimensional image according to an example embodiment of the present invention.

### DESCRIPTION OF EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein. Accordingly, example embodiments are to cover all modifications, equivalents, and alternatives falling within the scope of the invention.

It will be understood that, although the terms first, second, etc. may be used herein to describe various elements, these elements should not be limited by these terms. These terms are only used to distinguish one element from another.

It will be understood that, when a feature or element is referred to as being “connected” or “coupled” to another feature or element, it can be directly connected or coupled to the other element or intervening elements may be present. In contrast, when a feature or element is referred to as being “directly connected” or “directly coupled” to another element, there are no intervening elements present.

The terminology used herein is for the purpose of describing particular embodiments only and is not intended to be limiting of example embodiments of the invention. It will be understood that the terms “comprises,” or “includes,” when used herein, specify the presence of stated features, integers, steps, operations, elements, and/or components, but do not preclude the presence or addition of one or more other features, integers, steps, operations, elements, components, and/or groups thereof.

Like numbers are used throughout the drawings to refer to the same or like parts and a repetitive explanation will be omitted. Detailed descriptions of well-known functions and structures incorporated herein may be omitted to avoid obscuring the subject matter of the present invention.

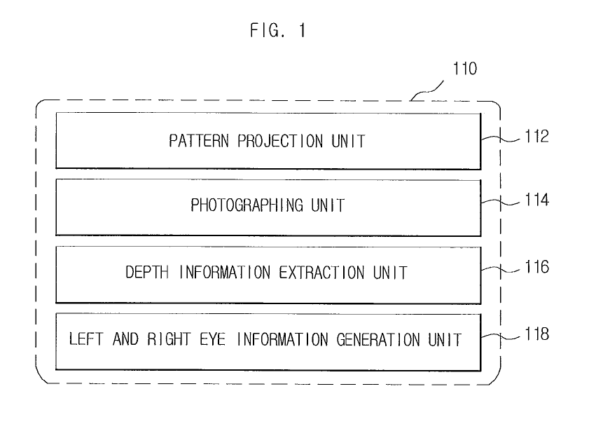

FIG. 1 is a block diagram illustrating a three dimensional image processing apparatus according to an example embodiment of the present invention. Referring to FIG. 1, a lattice pattern projection unit 112, a photographing unit 114, a depth information extraction unit 116 and a left and right eye information generation unit 118 are illustrated.

In this example embodiment, a projection light having a lattice pattern is projected onto a photographic object, which is then photographed by a camera. Once photographing is taken place, a left and right eye information is generated based on a modified shape of the lattice pattern so that a three dimensional information of the photographic object can be obtained. Here, the example embodiment is characterized in that the photographing unit 114 has a single lens for photographing an operative site.

The lattice pattern projection unit 112 projects a reference lattice pattern onto the photographic object. The reference lattice pattern is a lattice pattern projected onto the photographic object and is distinguished from a modified lattice pattern having a modified shape after the reference lattice pattern is projected onto the photographic object. For example, the lattice pattern projection unit 112 may be a laser oscillator that emits a laser light with good straight alignment. Also, the reference lattice pattern may have a predetermined pattern, for example, a circular or striped pattern or a square pattern created by horizontal lines running across vertical lines.

The lattice pattern projection unit 112 may be coupled to an endoscope and inserted into a body to emit the lattice pattern. In this case, the lattice pattern projection unit 112 may be rotatably engaged with the endoscope. For example, the lattice pattern projection unit 112 may be engaged with the endoscope by using a hinge connection. In addition, when the endoscope is implemented in a snake-type or flexible scope, the lattice pattern projection unit 112 may be coupled to a particular portion of the endoscope to be inserted into the body and project the lattice pattern onto the photographic object as the endoscope is bent to reach a certain place in the body. Also, when a lens is positioned on a side surface of the endoscope to capture an image of the photographic object, the lattice pattern projection unit 112 may be located adjacent to the lens. It should be noted that various methods can be applied to the present invention to connect the lattice pattern projection unit 112 with the endoscope depending on a structure of the endoscope.

The photographing unit 114 generates an image information by photographing the photographic object onto which the above described reference lattice pattern is projected by using a lens. The image information can be a still image information or a video information. The photographing unit 114 can be any apparatus which is capable of capturing an image through a lens. For example, the photographing unit 114 can be a camera. The photographing unit 114 may include a storage unit, for example a memory, which stores the generated image information. In this example embodiment, since the photographing unit 114 includes only one lens, the photographing unit 114 becomes smaller in volume.

The depth information extraction unit 116 extracts a depth information of the photographic object by using the image information generated by photographing unit 114. For example, the depth information extraction unit 116 may extract the depth information of the photographic object by comparing the reference lattice pattern projected onto the photographic object with a modified lattice pattern included in the image information generated by the photographing unit 114. That is, the image information generated by the photographing unit 114 includes the modified lattice pattern resulted when the projected reference lattice pattern is modified in correspondence with the depth information of the photographic object. Therefore, by comparing the modified lattice pattern with the reference lattice pattern, the depth information of the photographic object can be obtained.

The depth information extraction unit 116 can extract the depth information of the photographic object based on an information of at least one of a distance between adjacent lines forming the modified lattice pattern, a width, a gradient or a variation of the gradient of the line. For example, when, based on comparison between the reference lattice pattern and the modified lattice pattern, it is determined by the depth information extraction unit 116 that the distance between the adjacent lines of the modified lattice pattern is smaller than that of the reference lattice pattern, the photographic object is determined to be inclined.

In addition, when, based on comparison between the reference lattice pattern and the modified lattice pattern, it is determined by the depth information extraction unit 116 that the width of the line of the modified lattice pattern is smaller than that of the reference lattice pattern, it can be determined that the photographic object is located at a relatively far distance away from the photographing unit 114. Therefore, if the distance between the adjacent lines of the modified lattice pattern becomes shorter than that of the reference lattice pattern and the width of the line of the modified lattice pattern becomes shorter than that of the reference lattice pattern, it can be determined by the depth information extraction unit 116 that the photographic object moves further away from the photographing unit 114.

In addition, the depth information extraction unit 116 may extract an information about a direction of the gradient of the photographic object based on comparison between the gradient of the line of the modified lattice pattern and that of the reference lattice pattern. Also, the depth information extraction unit 116 may extract information about a boundary curvature defined by an irregular surface of the photographic object by measuring the variation of the gradient of the line. It should be noted that other various methods known to those skilled in the art can be applied to extract the depth information.

The left and right eye information generation unit 118 generates the left and right eye information, which is the three dimensional information of the photographic object corresponding to the depth information extracted by the depth information extraction unit 116. Specifically, the left and right eye information generation unit 118 may first generate the three dimensional information of the photographic object corresponding to the extracted depth information, and may generate the left and right eye information based on the generated three dimensional information, wherein the left and right eye information is an image information that corresponds to a perspective difference between left and right eyes of a viewer. The left and right eye information contains information about an image that is created by shifting a three dimensional image produced using the extracted depth information in a left or right direction according to the perspective difference between the left and right eyes. That is, the left and right eye information is the image information generated in correspondence with the perspective difference between the left and right eyes of the viewer. Thus, as described above, the left and right eye information generation unit 118 may generate the three dimensional image corresponding to the extracted depth information and generate the image information that corresponds to the perspective difference between the left and right eyes of the viewer based on the generated three dimensional information.

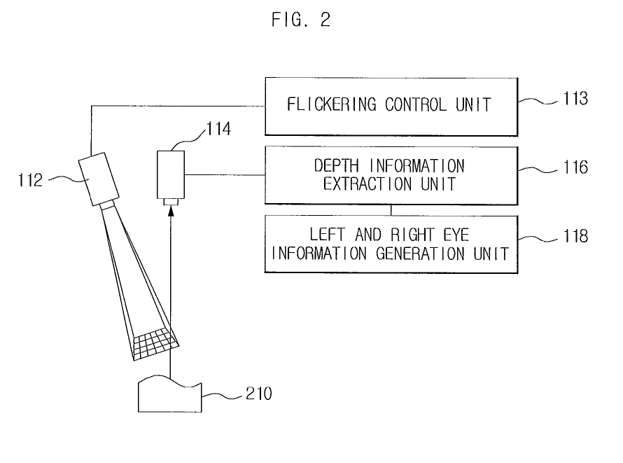

FIG. 2 is a block diagram illustrating a three dimensional image processing apparatus according to another example embodiment of the present invention. Referring to FIG. 2, the lattice pattern projection unit 112, a flickering control unit 113, the photographing unit 114, the depth information extraction unit 116, the left and right eye information generation unit 118 and a photographic object 210 are illustrated. The description below will be mainly focused on the difference between the embodiments of FIGS. 1 and 2.

In this example embodiment, projection of the above described reference lattice pattern onto the photographic object 210 is switched between on and off states at every predetermined period of time so that an actual image to be produced with a three dimensional effect may not include the reference lattice pattern. In other words, an image obtained by projecting the reference lattice pattern onto the photographic object 210 is used to extract the depth information, and an image obtained without projecting the reference lattice pattern onto the photographic object 210 is used to extract the left and right eye information. Therefore, a three dimensional image outputted to the viewer may not include the lattice pattern.

The flickering control unit 113 controls the lattice pattern projection unit 112 to turn on or turn off at every predetermined period. That is, the flickering control unit 113 may cause the projection light having the reference lattice pattern to flicker corresponding to the predetermined period. When the image information according to one example embodiment corresponds to a video information, the predetermined period can be such that a rate at which the flickering occurs is about 25 to 30 cycles or more per second because the human eye perceives a video image to be continuously on when the video image is displayed at about 25 to 30 frames per second (FPS). That is, the control of the flickering control unit 113 controls the projection light having the reference lattice pattern to flicker at least 25 times per second so that the photographing unit 114 can photograph the photographic object 210 onto which the reference lattice pattern is projected and the photographic object 210 onto which the reference lattice pattern is not projected, 25 times per second, respectively.

The photographing unit 114 may photograph the photographic object 210 onto which the reference lattice pattern is projected and the photographic object 210 onto which the reference lattice pattern is not projected, respectively, to generate the image information therefrom. The depth information extraction unit 116 may extract the depth information of the photographic object 210 based on the image information generated by photographing the photographic object 210 onto which the reference lattice pattern is projected, as described above. Here, the photographing unit 114 may alternately capture an image of the photographic object 210 onto which the reference lattice pattern is projected and the image of the photographic object 210 onto which the reference lattice pattern is not projected.

Also, the left and right eye information generation unit 118 may generate the left and right eye information that is the three dimensional information of the photographic object 210 in correspondence with the extracted depth information by using the image information generated by photographing the photographic object 210 onto which the reference lattice pattern is not projected.

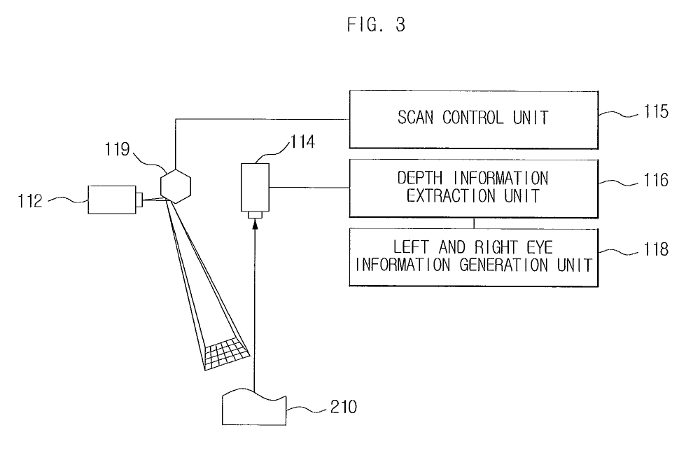

FIG. 3 is a block diagram illustrating a three dimensional image processing apparatus according to still another example embodiment of the present invention. Referring to FIG. 3, the lattice pattern projection unit 112, the photographing unit 114, a scan control unit 115, the depth information extraction unit 116, the left and right eye information generation unit 118, a mirror unit 119 and the photographic object 210 are illustrated. The description below will be mainly focused on the difference between the embodiment of FIG. 3 and other embodiments described above.

In this example embodiment, a certain type of tool, for example, the mirror unit 119 is used to correct a pathway of the projection light having the reference lattice pattern corresponding to the aforementioned period so that the projection of the reference lattice pattern onto the photographic object 210 is turned on or turned off during the predetermined period.

Here, the mirror unit 119 is a means to reflect a projection light emitted from the lattice pattern projection unit 112 in a direction toward the photographic object 210 in correspondence with the predetermined period. For example, a polygon mirror or a galvano mirror can be used for the mirror unit 119. That is, the mirror unit 119 is rotated corresponding to the predetermined period to reflect the projection light including the reference lattice pattern toward the photographic object 210 so that the reference lattice pattern may be projected onto the photographic object 210 during the predetermined period.

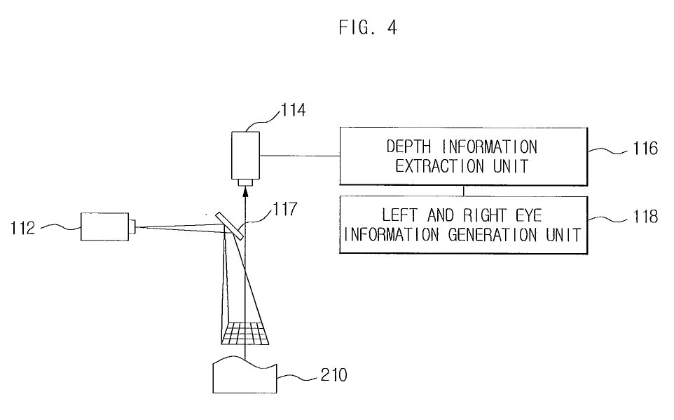

FIG. 4 is a block diagram illustrating a three dimensional image processing apparatus according to still another example embodiment of the present invention. Referring to FIG. 4, the lattice pattern projection unit 112, the photographing unit 114, the depth information extraction unit 116, a prism 117, the left and right eye information generation unit 118 and the photographic object 210 are illustrated. The description below will be mainly focused on the difference between the embodiment of FIG. 3 and other embodiments described above.

In this example embodiment, the prism 117 is used to alter the pathway of the projection light that includes the reference lattice pattern. According to this example embodiment, since the prism 117 can change the pathway of the projection light, the lattice pattern projection unit 112 can be positioned at a desired location. That is, as illustrated in FIG. 4, even when the lattice pattern projection unit 112 is not located on a line that passes through the photographing unit 114 and the photographic object 210, the prism 117 may control the projection light to proceed in a direction from the photographing unit 114 toward the photographic object 210. Under this structure, the lattice pattern projection unit 112 can be placed at various locations so that maximizing space efficiency within the apparatus is available. In this and following example embodiments, it is the same as described above that the depth information can be extracted from the image of the photographic object 210 onto which the reference lattice pattern is projected and the left and right eye information can be obtained by applying the depth information to the photographic object 210 onto which the reference lattice pattern is not projected.

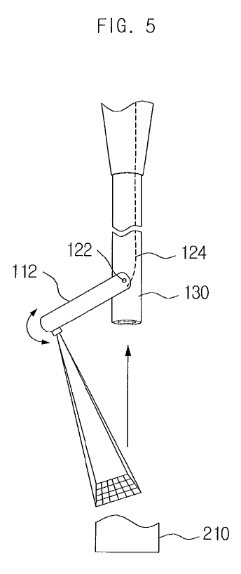

FIGS. 5 through 9 illustrate a state of a three dimensional image processing apparatus according to the above described example embodiments of the present invention being coupled to an endoscope. The description below will be mainly focused on the differences among the embodiments of FIGS. 5 through 9 and the differences between the embodiments of FIGS. 5 through 9 and other embodiments described above, respectively.

Referring to FIG. 5, the lattice pattern projection unit 112 is engaged with an endoscope body 130 and a hinge 122. When the endoscope is inserted into a patient's body, the lattice pattern projection unit 112 is rotated such that the lattice pattern projection unit 112 is positioned on the same extension line as the endoscope body 130. Also, when a photograph needs to be taken, the lattice pattern projection unit 112 is rotated such that the lattice pattern projection unit 112 forms a predetermined angle with respect to the extension line of the endoscope body 130 in order for the lattice pattern to be projected onto the photographic object 120.

In this example embodiment, a rotation means that is coupled to one end of the lattice pattern projection unit 112 may further be included to rotate the lattice pattern projection unit 112. Here, the rotation means can be a wire, a gear or a bar type rod. In the example of a wire 124 illustrated in FIG. 5, which is intended for illustrative purposes, a first end of the wire 124 is coupled to the lattice pattern projection unit 112 such that the first end of the wire 124 is spaced a predetermined distance apart from a center of the hinge 122. Therefore, when the wire 124 is tightened upward, the lattice pattern projection unit 112 is caused to move in a counterclockwise direction with respect to the hinge 122 due to a torque generated by the tightened wire 124. A second end of the wire 124 is connected to a manipulation unit (not shown) that can be manipulated by a user. On the other hand, in order to cause the lattice pattern projection unit 112 to move in a clockwise direction, a separate wire or a spring can be used to generate a clockwise torque. For example, the spring can be a V-shaped spring that is coupled to the hinge 122. It should be noted that various mechanisms can be applied to the present invention to rotate the lattice pattern projection unit 112.

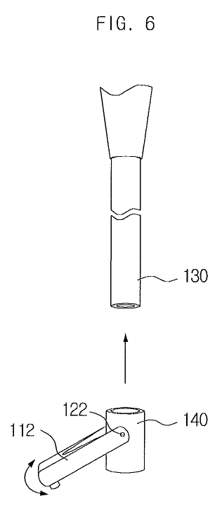

Referring to FIG. 6, the lattice pattern projection unit 112 is coupled to an engagement unit 140 via the hinge 122 as described above and the engagement unit 140 is coupled to the endoscope body 130. One end of the endoscope body 130 is inserted into the engagement unit 140, wherein, after the insertion, the lattice pattern projection unit 112 has the same function, the same operation method and the same functional connection structure with other elements as described above. That is, the lattice pattern projection unit 112 is modularized together with the engagement unit 140 to be connected to the endoscope body 130 in an attachable/detachable manner. Referring to FIG. 6, the endoscope body 130 is coaxially connected to the engagement unit 140 such that the endoscope body 130 is inserted into an inside of the tubular-shaped engagement unit 140 in an extension direction thereof. It should be noted that other various connection methods can be applied to couple the endoscope body 130 and the engagement unit 140. The above described approach is advantageous in that the present invention can easily be implemented because the lattice pattern projection unit 112 according to one example embodiment of the present invention can be mechanically coupled to the conventional endoscope.

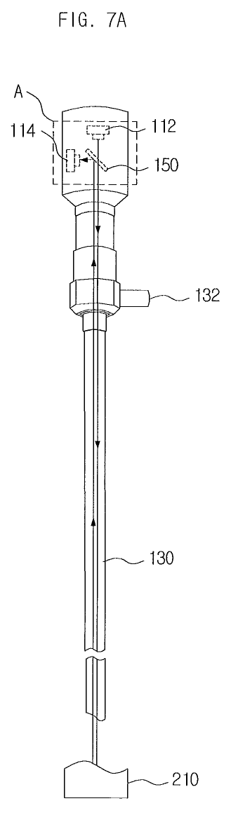

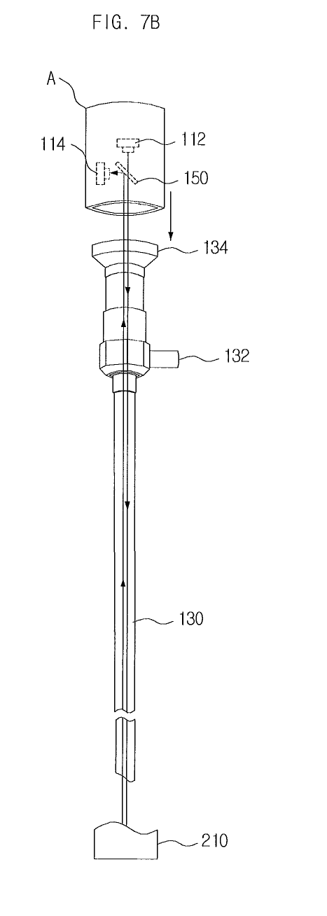

Referring to FIG. 7A, an optical unit A including the lattice pattern projection unit 112, the photographing unit 114 and the first mirror 150 is embedded within an endoscope that includes the endoscope body 130 and a light source connection unit 132. In other words, in this example embodiment, an optical unit is embedded within the endoscope body 130 to control a pathway of a light. The first mirror 150 allows a projection light that is emitted from the lattice pattern projection unit 112 and is incident on a first side surface thereof to pass therethrough and reflects a light that is reflected from the photographic object 210 and is incident on a second side surface thereof. Under this structure, the lattice pattern projection unit 112 does not need to be on the same direction as the photographing unit 114, i.e., the lattice pattern projection unit 112 and the photographing unit 114 may face different directions. Here, the first mirror 150 may be a one-way mirror or an electro-optic modulator (EOM).

Referring to FIG. 7B, the optical unit A including the lattice pattern projection unit 112, the photographing unit 114 and the first mirror 150 is provided as a separate member that is attachable/detachable to/from the endoscope body 130. The optical unit A is engaged with one end of the endoscope, for example, where an ocular lens 134 is positioned. Other functional units such as the aforementioned depth information extraction unit 116 and the left and right eye information generation unit 118 can be embedded in a device such as the optical unit A or provided as a separate device capable of communicating with the optical unit A. Various methods can be used to couple the optical unit to the endoscope. For example, the endoscope body 130 can be coaxially connected to the optical unit A such that the endoscope body 130 is inserted into an inside of the tubular-shaped optical unit A in an extension direction thereof. In this case, it is advantageous in that an inventive device according to the present invention is modularized so that the present invention can easily be implemented by coupling the inventive device to the conventional endoscope.

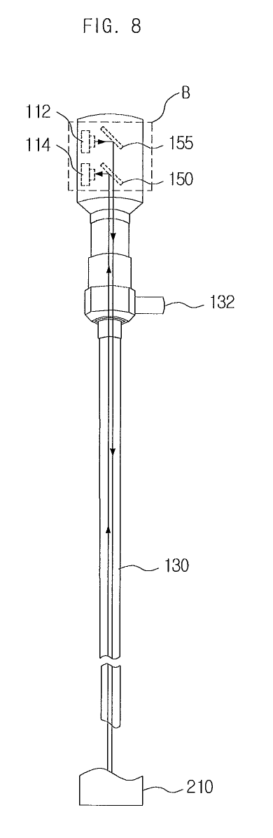

Referring to FIG. 8, another optical system B having a different structure from the above described embodiment is illustrated. That is, a second mirror 155 is positioned in a front end of the lattice pattern projection unit 112 so that the lattice pattern projection unit 112 is arranged to be in the same direction as the photographing unit 114. The second mirror 155 reflects the projection light emitted from the lattice pattern projection unit 112 in a direction toward the first mirror 150. Similar to the optical unit A in FIGS. 7A and 7B, the optical system B may also be modularized and provided as a separate unit, which is attachable/detachable to/from the endoscope body 130.

In the above, it is described that an optical system includes not more than two mirrors; however, it should be noted that an optical system may have more than two mirrors in an alternative embodiment. Also, example embodiments of the present invention may employ an alternative configuration of the optical system to provide effective arrangement of the lattice pattern projection unit 112 and the photographing unit 114.

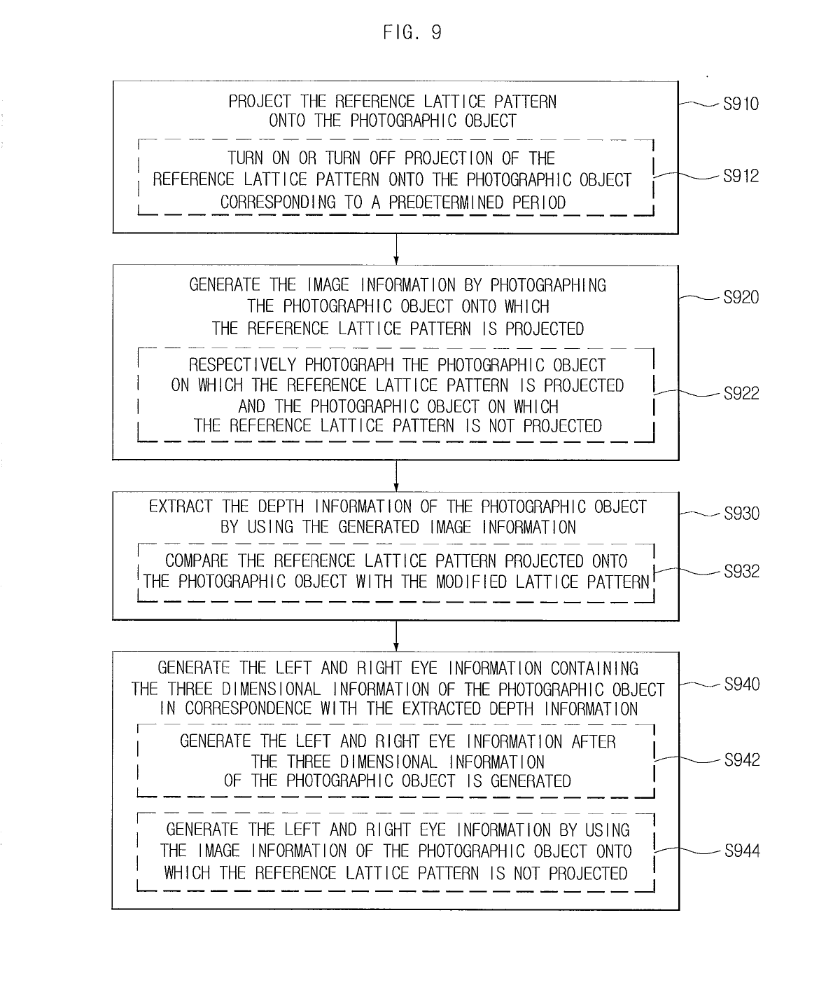

FIG. 9 is a flowchart illustrating a method of processing a three dimensional image according to an example embodiment of the present invention.

In step S910, the reference lattice pattern is projected onto the photographic object 210 by the lattice pattern projection unit 112. In step S912, in order for an actual image to be produced not to include the reference lattice pattern, the lattice pattern projection unit 112 projects the reference lattice pattern onto the photographic object 210 in a manner such that projection of the reference lattice pattern is turned on during a turn-on period and is turned off during a turn-off period. Such periodic projection can be performed by controlling the driving of the flickering control unit 113 or the mirror unit 119.

In step S920, the photographing unit 114 generates the image information by photographing the photographic object onto which the reference lattice pattern is projected using a lens. Specifically, in step S922, the photographing unit 114 photographs the photographic object 210 on which the reference lattice pattern is projected and the photographic object 210 on which the reference lattice pattern is not projected to generate the image information therefrom, respectively. As discussed in the above, the image information generated by photographing the photographic object 210 onto which the reference lattice pattern is projected is used to obtain the depth information of the photographic object 210. Also, the image information generated by photographing the photographic object 210 onto which the reference lattice pattern is not projected is used to obtain the left and right eye information, i.e., the three dimensional information of the photographic object 210.

In step S930, the depth information extraction unit 116 extracts the depth information of the photographic object 210 based on the generated image information. Various methods can be used to extract the depth information. For example, in step S932, the depth information of the photographic object 210 is extracted based on comparison by the depth information extraction unit 116 between the reference lattice pattern projected onto the photographic object 210 and the modified lattice pattern included in the image information generated by the photographing unit 114. That is, the depth information extraction unit 116 may extract the depth information of the photographic object 210 by using, for example, the distance between the adjacent lines of the modified lattice pattern, the width, the gradient or the variation of the gradient of the line.

In step S940, the left and right eye information generation unit 118 generates the left and right eye information, which is the three dimensional information of the photographic object 210, corresponding to the extracted depth information. Specifically, in step S942, the left and right eye information generation unit 118 may generate the three dimensional information of the photographic object 210 corresponding to the extracted depth information and generate the left and right eye information, which is the image information that corresponds to the perspective difference between the left and right eyes of the viewer, based on the generated three dimensional information. Also, in step S944, the left and right eye information generation unit 118 may generate the left and right eye information, which is the three dimensional information of the photographic object 210, in correspondence with the extracted depth information by using the image information generated by photographing the photographic object 210 onto which the reference lattice pattern is not projected.

Other technologies including technology for standardization of an image processing apparatus according to example embodiments of the present invention, common platform technology using an embedded system and an O/S, interface standardization technology using communication protocols and I/O interfaces, and technology for standardizing components such as an actuator, a battery, a camera and a sensor are well known to those skilled in the art, and thus a detailed description thereof will be omitted.

A method of processing a 3D image according to one example embodiment of the present invention may be implemented in a form of a program command executable through a variety of computer means and recordable to computer readable media. That is, the computer readable media may store programs, which is executable by a computer, to perform steps described above.

The computer readable media may include magnetic media such as hard disk, floppy disk and magnetic tape, optical media such as CD-ROM and DVD, magneto-optical media such as floptical disk and hardware devices such as ROM, RAM and flash memory specially designed to store and carry out programs.

In the above, the apparatus and the method for processing the 3D image according to example embodiments of the present invention are described particularly with respect to components such as the flickering control unit or the mirror unit provided in respective embodiments thereof. However, it should be noted that the present invention may be embodied in many alternate forms and should not be construed as limited to only the example embodiments set forth herein. For example, various elements can be combined together or a plurality of the mirror units can be utilized to diversify a pathway of the projection light. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus for processing a three dimensional image, the apparatus comprising:
a lattice pattern projection unit configured to project a reference lattice pattern onto a photographic object;
a photographing unit configured to generate an image information by photographing the photographic object onto which the reference lattice pattern is projected;
a depth information extraction unit configured to extract a depth information of the photographic object based on comparison between the reference lattice pattern projected onto the photographic object and a modified lattice pattern included in the image information; and
a left and right eye information generation unit configured to generate a left and right eye information in correspondence with the depth information, the left and right eye information containing a three dimensional information of the photographic object.

2. The apparatus according to claim 1, wherein the depth information of the photographic object is extracted by the depth information extraction unit by using an information of at least one of a distance between adjacent lines forming the modified lattice pattern, a width, a gradient or a variation of the gradient of the line.

3. The apparatus according to claim 1, wherein projection of the reference lattice pattern by the lattice pattern projection unit onto the photographic unit is turned on or turned off corresponding to a predetermined period.

4. The apparatus according to claim 3, wherein the lattice pattern projection unit includes a flickering control unit that controls such that a projection light including the reference lattice pattern flickers corresponding to the predetermined period.

5. The apparatus according to claim 3, wherein the lattice pattern projection unit includes a mirror unit configured to rotate corresponding to the predetermined period to reflect a projection light including the reference lattice pattern toward the photographic object.

6. The apparatus according to claim 1, wherein the lattice pattern projection unit includes a prism configured to refract a projection light including the reference lattice pattern in a direction toward the photographic object.

7. The apparatus according to claim 3, wherein the photographing unit photographs the photographic object onto which the reference lattice pattern is projected and the photographic object onto which the reference lattice pattern is not projected, respectively, to generate the image information.

8. The apparatus according to claim 7, wherein the left and right eye information generation unit generates the left and right eye information that contains the three dimensional information of the photographic object in correspondence with the depth information by using the image information generated by photographing the photographic object onto which the reference lattice pattern is not projected.

9. The apparatus according to claim 1, wherein the lattice pattern projection unit is coupled to an endoscope.

10. The apparatus according to claim 9, wherein the lattice pattern projection unit is rotatably coupled to the endoscope by using a hinge connection.

11. The apparatus according to claim 10, further comprising a rotation means coupled to one end of the lattice pattern projection unit to rotate the lattice pattern projection unit.

12. The apparatus according to claim 1, further comprising a first mirror configured to allow a projection light that is emitted from the lattice pattern projection unit and is incident on a first surface thereof to pass therethrough and configured to reflect a light that is reflected from the photographic object and is incident on a second surface thereof.

13. The apparatus according to claim 12, wherein an optical unit including the lattice pattern projection unit, the photographing unit and the first mirror is positioned within an endoscope or is provided in a separate device that is attachable/detachable to/from the endoscope.

14. The apparatus according to claim 12, further comprising a second minor positioned in a front end of the lattice pattern projection unit to reflect the projection light toward the first mirror.

15. The apparatus according to claim 14, wherein an optical unit including the lattice pattern projection unit, the photographing unit, the first mirror and the second minor is positioned within an endoscope or is provided in a separate device that is attachable/detachable to/from the endoscope.

16. A method of processing a three dimensional image, the method comprising:
projecting a reference lattice pattern onto a photographic object;
generating an image information by photographing the photographic object onto which the reference lattice pattern is projected;
extracting a depth information of the photographic object based on comparison between the reference lattice pattern projected onto the photographic object and a modified lattice pattern included in the image information; and
generating a left and right eye information in correspondence with the depth information, the left and right eye information containing a three dimensional information of the photographic object.

17. The method according to claim 16, wherein, in the extracting of the depth information, the depth information of the photographic object is extracted by using an information of at least one of a distance between adjacent lines forming the modified lattice pattern, a width, a gradient or a variation of the gradient of the line.

18. The method according to claim 16, wherein, in the projecting of the reference lattice pattern, projection of the reference lattice pattern onto the photographic unit is turned on or turned off corresponding to a predetermined period.

19. The method according to claim 18, wherein, in the generating of the image information, the photographic object onto which the reference lattice pattern is projected and the photographic object onto which the reference lattice pattern is not projected are respectively photographed to generate the image information.

20. The method according to claim 19, wherein, in the generating of the left and right eye information, the left and right eye information that contains the three dimensional information of the photographic object is generated in correspondence with the depth information by using the image information generated by photographing the photographic object onto which the reference lattice pattern is not projected.
